(19) United States
(12) Patent Application Publication
(10) Pub. No.: US 2019/0169854 A1
(43) Pub. Date: Jun. 6, 2019

(54) DECORATIVE BALUSTERS

(71) Applicant: 1461043 ONTARIO LIMITED, Caledon (CA)

(72) Inventor: CARLOS PACHECO, CALEDON (CA)

(21) Appl. No.: 15/875,811

(22) Filed: Jan. 19, 2018

Related U.S. Application Data
(60) Provisional application No. 62/593,524, filed on Dec. 1, 2017.

(51) Int. Cl. E04F 11/18; F21V 8/00

(52) U.S. Cl. CPC E04F 11/1842; G02B 6/0075; E04F 2011/1897; E04F 2011/1872; G02B 6/0081

(57) ABSTRACT

A longitudinally elongated resilient plastic wrapping for wrapping around a railing baluster, has a tubular shape, a longitudinally extending end-to-end slit, and a decorative surface pattern. In a balustrade, a wrapping may be provided around each of the balusters. To install a wrapping, it is opened along its longitudinal slit so that the wrapping can receive a baluster, it is placed over the baluster and worked the wrapping so that it snugly receives said baluster.

### CROSS-REFERENCE TO RELATED APPLICATION

The present application claims the benefit of prior provisional application Ser. No. 62/593,524, filed Dec. 1, 2017, the contents of which are hereby incorporated herein by reference.

### BACKGROUND

Balusters are used to support railings of stairs, decks, and patios. Balusters are typically decorative in design to enhance the visual appeal of a balustrade.

A user may wish to alter the look of the balusters but may be reluctant to do so due to the cost and time needed to replace the balusters by reconstructing the railing.

### SUMMARY

To address this problem, decorative wrappings are provided which may be wrapped around the balusters of the railing. Each wrapping can have an end-to-end longitudinal slit to allow its installation.

Where the railing balusters are of uniform cross-section, the wrapping can be made of resilient plastic and be tubular with a closed cross-sectional shape matching the cross-sectional shape of the balusters.

Where the balusters have a varying cross-section, each wrapping can be a heat shrinkable plastic which is wrapped around a baluster and then shrunk in place using heat.

### BRIEF DESCRIPTION OF THE DRAWINGS

In the figures which illustrate example embodiments,

FIG. 1 is a front view of a portion of a balustrade in accordance with an embodiment;

FIG. 2 is a cross-sectional view along the lines II-II of FIG. 1;

FIG. 2A is an alternate cross-sectional view along the lines II-II of FIG. 1;

FIG. 3 is a perspective view of a wrapping of FIG. 1;

FIG. 4 is a front view of a portion of a balustrade in accordance with another embodiment;

FIG. 5 is a front view of a portion of a balustrade in accordance with a further embodiment:

FIG. 6 is a cross-sectional view along the lines VI-VI of FIG. 5;

FIG. 7 is a front view of a wrapping which has been unfurled;

FIG. 8 is a longitudinal sectional view of a baluster showing a dryer, in accordance with another embodiment; and

FIG. 9 is a cross-sectional view along the lines IX-IX of FIG. 8.

### DETAILED DESCRIPTION

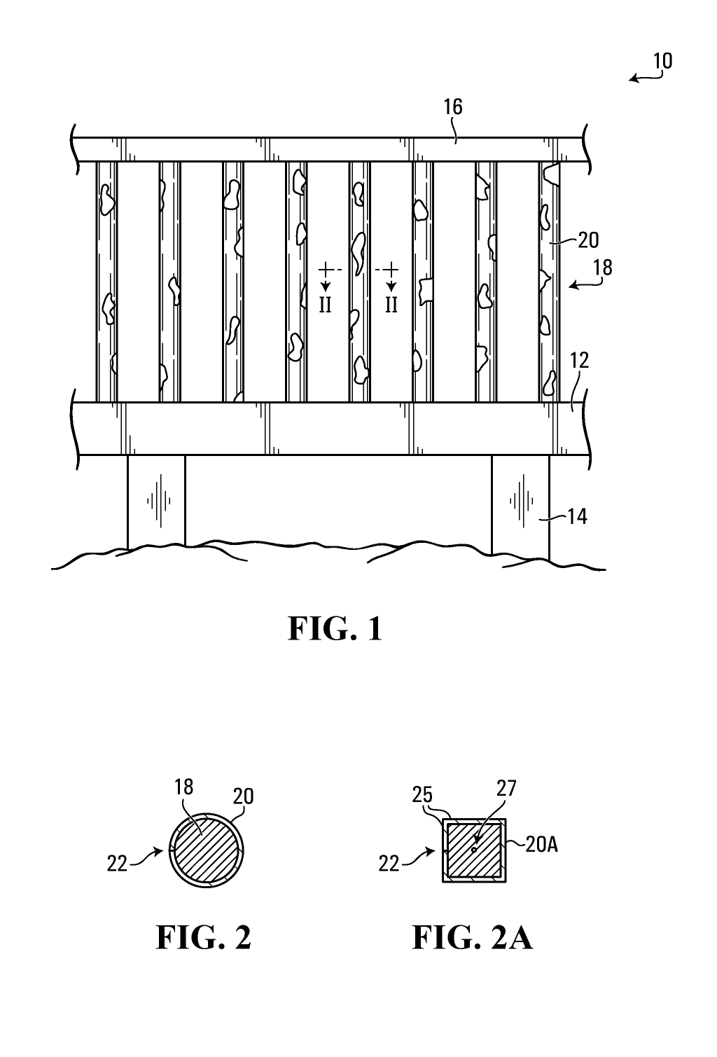

Turning to FIG. 1, a balustrade 10 has a deck 12 supported by supports 14 and a handrail 16 supported by balusters 18 extending between the deck and handrail. Each railing baluster is wrapped by a wrapping 20.

With reference to FIG. 2, which is a cross-sectional view of one of the balusters 18, wrapping 20 is a round tube with an end-to-end longitudinal slit 22. The interior diameter of the tubular wrapping is the same as (or slightly smaller than) the diameter of the cross-section of the baluster such that the open ends of the slit just meet (or leave a slight opening) when the tubular wrapping extends around the baluster. Alternatively, as shown in FIG. 2A, where the balusters have a square cross-section, the tubular wrapping 20A also has a square cross-section. Where the wrapping 20A has a square cross-section, as illustrated, the longitudinal slit 22 can bisect one of the planar faces 25 of the wrapping.

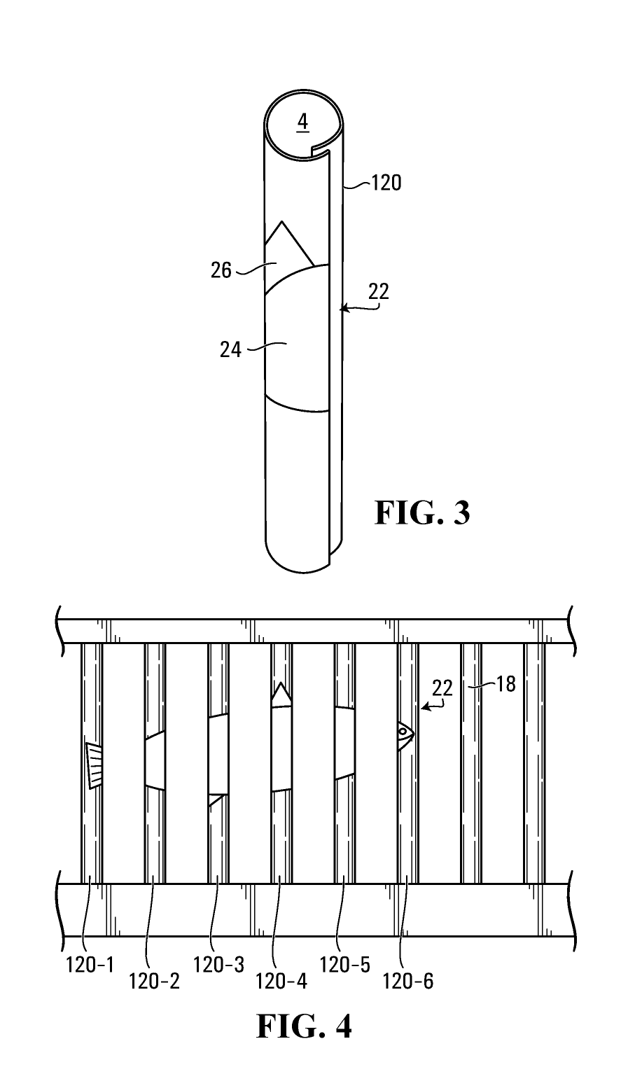

With brief reference to FIG. 3, tubular wrapping 120 is fabricated of resilient plastic such that when it is not wrapped around a baluster it will curl in on itself and form an overlap along the longitudinal slit 22.

To install a resilient tubular wrapping on a baluster, the closed tubular wrapping is worked so that it is opened along its longitudinal slit 22 by overcoming the recovery force imparted by the resilient plastic to create a mouth large enough to receive a baluster. The tube is then placed over the baluster and released, whereupon the resilient plastic tube closes around the baluster. With the interior diameter of the tube, once closed, matching the diameter of the baluster, the tube will snugly receive the baluster. Ideally, when closed around the baluster, the edges of the tubular wrapping on either side of the longitudinal slit abut. For aesthetic reasons, the wrappings can be oriented such that the longitudinal slit of each is at a side of each baluster such that these slits lie within the line of the balusters and are thus not in the line of sight when looking at the balusters from either in front of, or behind, the balustrade.

As illustrated in FIG. 1, each tubular wrapping can have the same decorative surface pattern or decorative surface patterns that are essentially randomly different. Alternatively, the decorative surface pattern may vary in a defined way from wrapping to wrapping. In this instance, sets of wrappings can be provided so that a wrapping set provides an overall pattern on the balusters as, for example, to create an image of a flag or a fish. FIGS. 3 and 4 illustrate a wrapping set.

Turning to FIG. 3, tubular wrapping 120 has a pattern which is a portion of an image of a fish, namely a portion of the body 24 of the fish and a portion of the dorsal fin 26 of the fish. The wrapping also has, on its interior surface near the top, a number, in this instance the number four, which indicates the ordinal portion of the baluster around which tubular wrapping 120 should be wrapped. In the example set of wrappings, there are six wrappings in a set and these are illustrated wrapping the ballisters of FIG. 4. Turning to FIG. 4, wrappings 120-1 to 120-6 are illustrated as wrapping consecutive balusters 18. Each of wrappings 120-1 to 120-6 has a decorative pattern with a different portion of an image of a fish such that when all six wrappings are in place they give the visual impression of an entire fish. The gaps in the image of the fish between balusters are filled in by the viewer's eye and, indeed, the viewer may have the visual impression of seeing a fish in reeds. The position of the decorative surface pattern on the wrappings in relation to the longitudinal slit is chosen so that the pattern of the set will be properly displayed at the front (and optionally also at the back) of the baluster if these slits have a certain orientation on each baluster. With the surface pattern located as shown on the wrapping 120 of FIG. 3, the pattern of the set will be properly displayed if the longitudinal slit 22 of each wrapping 120-1 to 120-6 is at the right hand side of the baluster 18 around which it is wrapped and the longitudinal slits are aligned with each other and with the centrelines 27 (FIG. 2A) of the balusters.

While the overall pattern has been shown to have been achieved by six wrappings, clearly a pattern forming set may have a different number of wrappings. Indeed, with the set shown, the seventh and eighth balusters could be wrapped with further wrappings of the set which have a neutral pattern, prior to the pattern repeating or a different pattern following.

Significantly, with the wrapping, it would be possible to complete a railing using unfinished balusters, such as balusters of unfinished wood, since the decorative wrappings will act to finish the surface of the balusters. Moreover, at any time a user may change the decorative wrappings for different decorative wrappings with different surface patterns. Thus, the wrappings can be used, for example, to present an appropriate theme for the railing, such as a holiday theme.

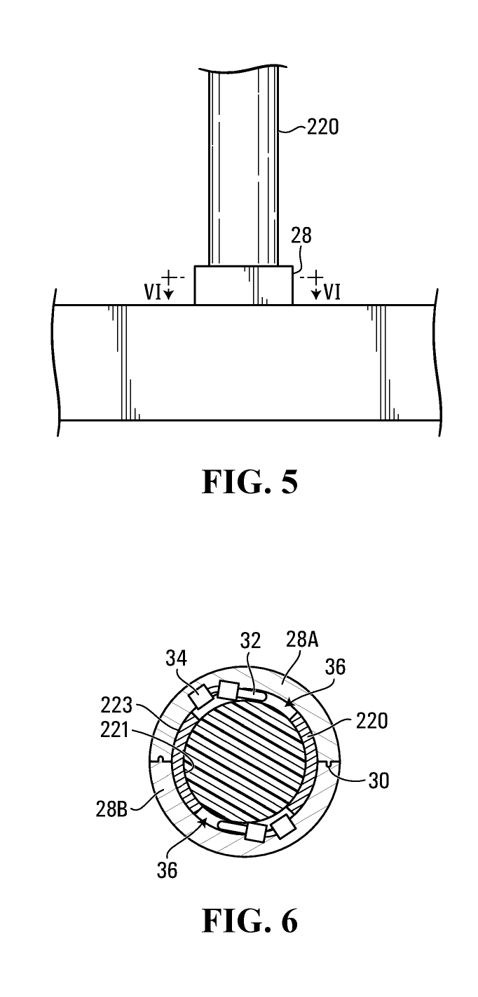

In another embodiment, each wrapping can be illuminated. More specifically, turning to FIGS. 5 and 6, each wrapping 220 is a side emitting light guide. This may be achieved by each wrapping comprising a flexible plastic substrate 221 supporting a thin film light guide 223 of the type described in U.S. Pat. No. 9,110,200, the contents of which are incorporated herein by reference. With the wrappings being light guides, a light engine is coupled to one end of each wrapping. Specifically, a two piece collar 28 has halves 28A and 28b with snaps 30 that allow the two halves to be snapped together around the base of the baluster 18 and wrapping 220. Each collar half supports an LED 32 and battery 34 powering the LED 32. Wrapping 220 has two circumferentially extending slots 36 so that the collar halves can be oriented so that the LEDs extend into slots 36 to feed light along the wrapping 220. If more luminous balusters are desired, a second light engine within a second collar may be installed around the baluster at the upper end of the wrapping.

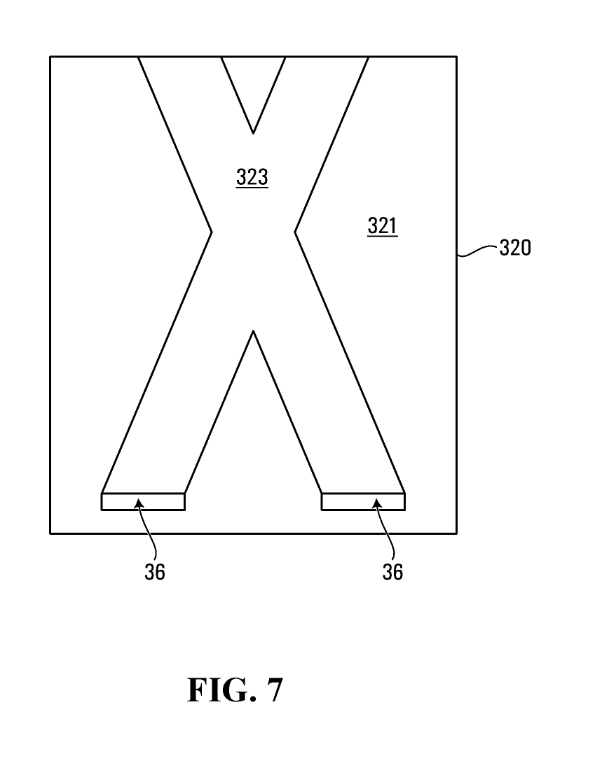

Optionally, the thin film light guides of the wrappings may be configured to, when guiding light, guide light so as to display a pattern on each wrapping. This embodiment is illustrated in FIG. 7 which shows an unfurled wrapping 320 with a substrate 321 and a thin film light guide 323. Thin film light guide 323 is patterned such that light directed into the wrapping at either slot 36 will follow the pattern provided by the thin film light guide so as to result in an illuminated display of the pattern on a baluster around which wrapping 320 is wrapped.

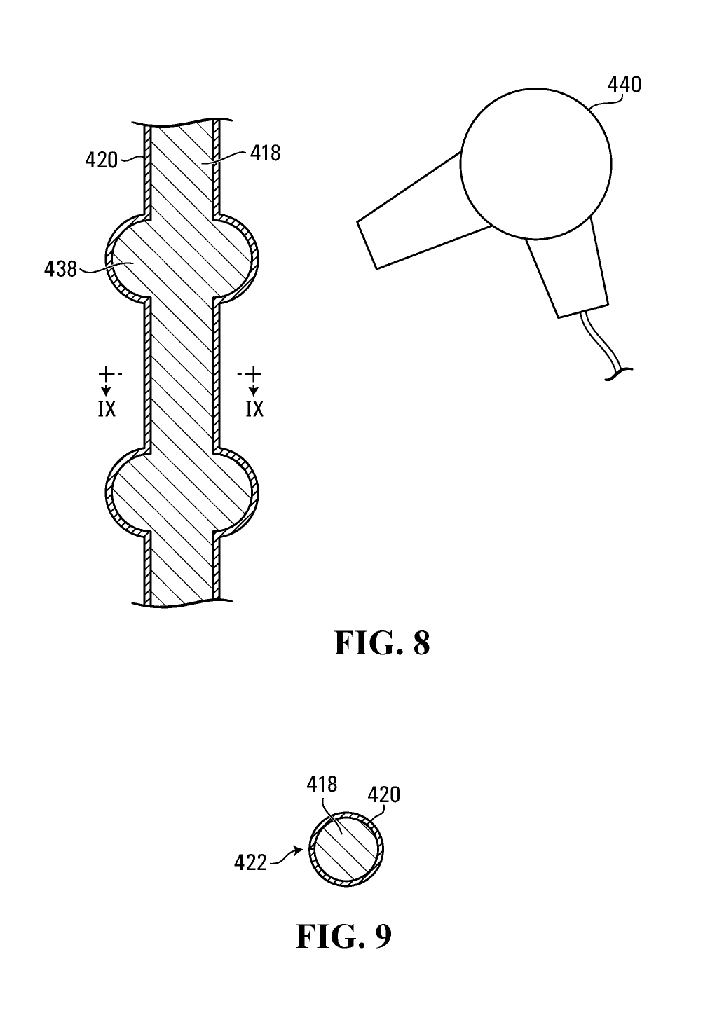

In another embodiment, the baluster has a changing cross-section and/or has intricacies in its shape. This possibility is illustrated in FIGS. 8 and 9 where baluster 418 has bulbous portions 438. In this instance, wrapping 420 with its longitudinal slit 422 is fabricated of a heat shrinkable plastic. In this instance, after placing the wrapping 420 around baluster 418, heat is applied to the wrapping, such as by hair dryer 440 so that the wrapping shrinks to snugly receive the baluster. As before, the wrapping may have a decorative surface pattern. With this embodiment, if it is desired to later change the pattern, the wrapping may first be peeled from the baluster to make way for a further heat shrinkable wrapping, or the further heat shrinkable wrapping may simply be applied over an underlying wrapping.

Other embodiments will be apparent to those skilled in the art.

What is claimed is:

1. A longitudinally elongated resilient plastic wrapping for wrapping around a railing baluster, said wrapping having a tubular shape, a longitudinally extending end-to-end slit, and a decorative surface pattern.

2. The wrapping of claim 1 wherein said wrapping curls in on itself such that longitudinal edges of said wrapping along said longitudinal slit overlap.

3. The wrapping of claim 2 wherein said wrapping is a round tube.

4. The wrapping of claim 2 wherein said wrapping is a square tube.

5. The wrapping of claim 4 wherein said longitudinal slit bisects a planar face of said square tube.

6. The wrapping of claim 2 wherein said wrapping comprises a side emitting light guide.

7. The wrapping of claim 6 wherein said side emitting light guide comprises a resilient plastic substrate supporting a thin film light guide.

8. The wrapping of claim 6 further comprising a light engine coupled to said light guide.

9. The wrapping of claim 8 further comprising a collar for surrounding said wrapping at a lower end of said wrapping, said light engine contained within said collar.

10. The wrapping of claim 9 wherein said collar is a two-piece collar, with one piece of said collar joined to another piece of said collar to complete said collar.

11. The wrapping of claim 8 wherein said thin film light guide covers a portion of said resilient plastic substrate and leaves another portion of said resilient plastic substrate free of said thin film light guide so as to provide a pattern on said resilient plastic substrate.

12. A balustrade comprising:
a plurality of balusters;
a plurality of longitudinally elongated wrappings, each wrapping having a longitudinally extending end-to-end slit and a decorative surface pattern, each wrapping wrapped around one of said balusters.

13. The balustrade of claim 12 wherein the decorative surface pattern of a given wrapping is different from the decorative surface pattern of an adjacent wrapping.

14. The balustrade of claim 12 wherein the decorative surface patterns of a given plurality of adjacent wrappings differ from one another so as to create a composite image.

15. The balustrade of claim 12 wherein each wrapping is a resilient plastic tube.

16. The balustrade of claim 12 wherein each wrapping is a heat shrunk plastic wrap.

17. The balustrade of claim 12 wherein longitudinal slits of each of the wrappings are aligned with each other and with a centre line of the balusters.

18. A method of finishing a balustrade comprising, for each of a plurality of balusters:
opening a tubular wrapping of a plurality of tubular wrappings along a longitudinal slit of said wrapping so that the wrapping can receive a baluster of said plurality of balusters;
placing the wrapping over said baluster;
working the wrapping so that the wrapping snugly receives said baluster.

19. The method of claim 18 wherein said wrapping is a resilient plastic wrapping such that said opening said wrapping comprises overcoming a recovery force imparted by the resilient plastic wrapping and wherein said working the wrapping comprises releasing the wrapping after placing the wrapping over said baluster so that said wrapping recovers to snugly receive said baluster.

20. The method of claim 18 wherein said wrapping is a heat shrinkable plastic wrapping and wherein said working comprises applying heat to said wrapping until said wrapping snugly receives said baluster.

21. The method of claim 17 wherein each of said plurality of wrappings has a different decorative surface pattern.
